(19) United States
(12) Patent Application Publication
(10) Pub. No.: US 2026/0360133 A1
(43) Pub. Date: Nov. 12, 2026

(54) Method for Ascertaining a Predictability of at Least One Object Proposal in an Object Detection

(71) Applicant: Robert Bosch GmbH, Stuttgart (DE)

(72) Inventor: Maximilian Menke, Diekholzen (DE)

(21) Appl. No.: 19/669,026

(22) Filed: May 6, 2026

(30) Foreign Application Priority Data
May 7, 2025 (DE) 10 2025 117 515.2

(51) Int. Cl. G06V 10/776; G06V 10/25; G06V 10/77; G06V 10/82; G06V 20/56

(52) U.S. Cl. CPC G06V 10/776; G06V 10/25; G06V 10/7715; G06V 10/82; G06V 20/56

(57) ABSTRACT

A method is disclosed for ascertaining predictability of at least one object proposal in object detection, wherein the predictability quantifies a probability of a presence of an object within the bounding box of the at least one object proposal. The method includes (i) providing an image, wherein the image results from an acquisition by at least one sensor of a technical system, (ii) extracting features of the image, (iii) generating the at least one object proposal on the basis of the extracted features, wherein the at least one object proposal includes a bounding box that describes a region within the image that is expected to include an object, and (iv) ascertaining the predictability for the at least one object proposal. A computer program, an apparatus, and a storage medium for this purpose are also disclosed.

### CROSS-REFERENCE TO RELATED APPLICATION

This application claims priority under 35 U.S.C. § 119 to patent application no. DE 10 2025 117 515.2, filed on May. 7, 2025 in Germany, the disclosure of which is incorporated herein by reference in its entirety.

The disclosure relates to a method for ascertaining a predictability of at least one object proposal in an object detection. Furthermore, the disclosure relates to a computer program, an apparatus, and a storage medium for this purpose.

### BACKGROUND

In the rapidly developing field of autonomous driving, deep learning technologies are at the forefront, which enable vehicles to navigate in complex environments with increasing autonomy. At the center of this progress are camera-based systems that rely on tasks such as object detection and semantic segmentation in order to accurately interpret the environment. However, the use of these autonomous systems depends on a decisive factor: safety. In order to ensure safety, a comprehensive understanding of the state of the machine learning models and their decision-making processes is required.

One of the greatest challenges in achieving this safety level is the quantification of uncertainties. It is of decisive importance that a machine learning model recognizes and communicates when it is not sufficiently certain of its decisions, in particular, when determining the presence of objects. Traditional methods for assessing this uncertainty, such as entropy values or ensemble methods, are limited in their scope. They primarily address true positive (TP) and false positive (FP) predictions and focus only on scenarios in which the machine learning model makes a prediction and corresponding ground truth is present. However, these methods do not take into account false negative (FN) cases, in which an object is present but the machine learning model does not detect it, thereby creating a gap in the quantification of uncertainty.

In the field of autonomous driving and computer vision, the concept of uncertainty estimation within object detection models has become a decisive focus of research. The process of uncertainty quantification traditionally depends on the ability of the machine learning model to predict the presence of an object, wherein methods such as entropy and Monte Carlo dropout are used, among others. These statistical methods are designed to measure the confidence level of the predictions of the machine learning model. A contribution to this field is made by a work entitled "Active Domain Adaptation with False Negative Prediction for Object Detection", in which an approach to uncertainty estimation is presented. This expands the conventional limits by examining a discrepancy between the number of objects predicted by the machine learning model and the actual object count that is verified by ground-truth data. This approach represents a shift toward the recognition and inclusion of false negative results in the framework of uncertainty analysis.

Despite advances in techniques for uncertainty estimation in object detection models, current methods according to the prior art exhibit significant limitations. The greatest limitation consists in that the machine learning model relies on scenarios in which it makes an object prediction, which inherently excludes cases of false-negative results, situations in which an object is present in the image but is not detected by the machine learning model. However, the method proposed in "Active Domain Adaptation with False Negative Prediction for Object Detection" focuses on the divergence in the total number of predicted and actual objects. This approach does not provide a detailed assessment of the prediction capabilities of the machine learning model in specific regions within an image. Consequently, there is a gap in current methods for a comprehensive assessment of the performance of a machine learning model, in particular, in the identification and quantification of the limitations of the machine learning model in detecting objects in specific regions of an image.

### SUMMARY

The present disclosure provides a method, a computer program, an apparatus, and a computer-readable storage medium having the features set forth below. Further features and details of the disclosure are apparent from the description and the drawings. Features and details that are described in connection with the method according to the disclosure naturally also apply in connection with the computer program according to the disclosure, the apparatus according to the disclosure, and the computer-readable storage medium according to the disclosure, and respectively vice versa, such that, with regard to the disclosure of the disclosure, mutual reference is always also possible.

The present disclosure provides, in particular, a method for ascertaining a predictability of at least one object proposal in an object detection, wherein the predictability quantifies a probability of a presence of an object within a bounding box of the at least one object proposal, comprising:
providing an image, wherein the image results from an acquisition of at least one sensor, for example, a camera sensor, a radar sensor, a lidar sensor, or a thermal imaging sensor, of a technical system, in particular, of a vehicle,
extracting features of the image,
generating the at least one object proposal on the basis of the extracted features, wherein the at least one object proposal comprises a bounding box that describes a region within the image that is expected to comprise an object,
ascertaining the predictability, in particular, a value for the predictability, for example, a percentage or a value between 0 and 1, for the at least one object proposal.

This has the advantage that the reliability of the object detection may be assessed and that it is possible to react, for example, in situations having high unpredictability, that is to say, in particular, low predictability. By quantifying the predictability, the object detection may be evaluated more transparently and corresponding decisions may be made, for example, whether the object detection may be trusted and automated control is possible or whether manual control by a driver should instead be activated.

The extracting of the features is preferably configured such that characteristic feature representations are derived from the sensor data, for example, camera data, radar data, or lidar data, which are suitable, for example, for a subsequent object detection or classification. The extracted features describe, for example, structural or contextual properties of detected objects that are represented in the sensor data. The extracting of the features is, in particular, data-driven, for example, by a machine learning model, in particular, a (deep) convolutional neural network, and may be based on parameters of the machine learning model ascertained in an upstream training process.

Furthermore, within the scope of the disclosure, it is optionally possible that the method further comprises:
comparing the ascertained predictability of each object proposal with a defined threshold value, for example, 50% or 0.5 or also 0,
carrying out at least one measure as a function of a result of the comparing.

This has the advantage that high-risk situations may be identified and corresponding measures may be initiated. By specifying the threshold value, it may be individually defined from which degree of unpredictability, or predictability, a reaction is required. This enables a proactive and safety-oriented procedure. It is also conceivable that individual threshold values are defined for respective measures.

Advantageously, it may be provided in the disclosure that the technical system is a vehicle and the at least one measure is selected from:
initiating automated control of the vehicle, for example, regular automated control when the predictability is present to a sufficient degree, that is to say exceeds the defined threshold value, or, for example, an emergency measure such as automated braking when the predictability undershoots the defined threshold value,
initiating a transition from automated control of the vehicle to manual control of the vehicle, in particular, when the predictability undershoots the defined threshold value,
initiating an output of a warning message in the vehicle, in particular, when the predictability undershoots the defined threshold value.

This allows the vehicle to react to the predictability of the object detection in a situation-dependent manner. This enables proactive behavior of the vehicle that may increase safety in road traffic. By initiating the automated control, the vehicle may autonomously handle the situation when the predictability is high or, optionally, initiate automated emergency measures when the predictability is low. In the case of high unpredictability, or low predictability, a transition to manual control may enable the driver to take control of the vehicle in a timely manner. The output of the warning message may inform the driver, for example, about potential hazards that may be present in regions that have the low predictability.

Optionally, it is conceivable that the method further comprises:
performing object detection on the basis of the extracted features of the image,
determining a respective relevance of the at least one generated object proposal, in particular, with regard to a current driving situation, on the basis of an analysis of a result of the object detection and a position of the at least one generated object proposal in the image,
wherein the at least one measure is furthermore carried out as a function of the determined respective relevance of the at least one generated object proposal. The relevance could be present, for example, when the at least one generated object proposal is located in the driving direction in front of the vehicle and a collision would be possible. It is also conceivable that the at least one generated object proposal moves toward the vehicle in such a way that a collision would be possible. In this way, a targeted and situation-dependent approach may be provided. Taking into account the relevance, in particular, for the current driving situation, makes it possible to avoid unnecessary interventions and to use resources efficiently. The dynamic adaptation of the measures as a function of the relevance of the object proposal increases the accuracy and effectiveness of the system. This contributes to the safety and reliability of the vehicle.

Advantageously, it may be provided within the scope of the disclosure that the method further comprises:
determining an uncertainty of the bounding box of the at least one generated object proposal,
wherein the at least one measure is furthermore carried out as a function of the determined uncertainty of the bounding box of the at least one generated object proposal. This allows the accuracy of the object detection to be assessed and the at least one measure to be taken as a function of this assessment. The adaptation to the respective uncertainty enables a dynamic response.

In a further possibility, it may be provided that the generating of the object proposals is carried out using a region proposal network and that the at least one object proposal is class-independent. A region proposal network (RPN) may be an element in object detection systems in the field of computer vision, for example, in so-called two-stage detectors such as Faster R-CNN. It is, in particular, a neural network that may extract potential regions from an image in which objects may be located. These regions are, in the context of the present disclosure, referred to, in particular, as object proposals (in English: "region proposals"). Initially, according to the disclosure, a respective input image may be passed through a convolutional network, in particular, a convolutional neural network (for example, ResNet), in order to extract features or generate a feature map. A small network, for example, a 3×3 filter, may subsequently be moved as a "sliding window" over this feature map. For each position of this sliding window, a plurality of so-called anchor boxes having predefined sizes and aspect ratios may be used, which may serve as reference frames for possible objects. Subsequently, fine adjustment of the anchor coordinates of the anchor boxes may be performed for more accurate localization. The RPN may replace traditional methods for region generation (such as, for example, selective search) by learning and integrating this task directly and efficiently within a deep neural network. It thus provides, in particular, fast, learnable, and image-adaptive generation of object proposals.

It may furthermore be possible that the ascertaining of the predictability is carried out using a trained machine learning model, wherein the machine learning model is trained in the context of a training that comprises at least the following steps:
providing training data, wherein the training data comprise individual images, wherein at least one bounding box is respectively assigned to the individual images, wherein at least a part of the bounding boxes comprises a representation of an object, wherein an annotation is respectively assigned to the bounding boxes, the annotation indicating whether the respective bounding box comprises the representation of the object or not,
predicting the probability of the presence of the object within the bounding boxes using the machine learning model,
checking, on the basis of the corresponding annotations, whether the respective bounding box comprises the representation of the object and the presence of the object was correctly predicted within the scope of the prediction,
adapting parameters of the machine learning model on the basis of a result of the checking.

Thus, by training the machine learning model, it is, in particular, learned to quantify the probability of the presence of an object within the bounding box. This capability makes it possible to ascertain the predictability of the object proposals and thus to identify potentially hazardous situations at an early stage.

It is possible that the method according to the disclosure is used in a vehicle. The vehicle may be embodied as, for example, a motor vehicle and/or a passenger motor vehicle and/or an at least partially automated or autonomous vehicle. The vehicle may comprise a vehicle device, for example, for providing an autonomous driving function and/or a driver assistance system. The vehicle device may be designed to at least partially automatically control and/or accelerate and/or decelerate and/or steer the vehicle.

The machine learning model that may be used for the object detection in the context of the method according to the disclosure is, in particular, trained for object detection. The training may be provided to train the machine learning model by way of a training data set for classification, in particular, for image classification, of image data such as digital images on the basis of image points and/or image pixels, in particular, pixel values, preferably edges or pixel attributes of the image data. The image data or digital images may result, for example, from a recording by at least one sensor, preferably at least one camera, more preferably of a vehicle, and most preferably of a camera and/or a vehicle environment during a journey of a vehicle. The recording is possible, for example, by at least one camera of the vehicle. The classification may be provided to recognize objects in an environment imaged by the image data or digital images and/or to detect a traffic scene.

The classification may be provided for various technical applications. One example is the application in the vehicle. On the basis of the classification, in particular at least one classification result, at least one control action, for example, for a vehicle or for another technical system, may be initiated and/or carried out.

A classification result may comprise at least one of the following results and/or be specific to at least one of the following results: a category of objects, an identification of objects, a position of objects and/or obstacles, for example, in a direction of travel or next to the direction of travel, a presence of obstacles, a description of a traffic scene, a hazard message, a number of objects, a type and/or position of lane markings and/or a lane boundary, a position and/or a state of traffic signal installations, a position of a roadway, or the like.

On the basis of the classification result, at least one control action for the vehicle may be initiated and/or carried out. The control action may comprise at least one of the following: braking, steering, accelerating, an overtaking maneuver, emergency braking, activation of an alarm system, activation of a hazard warning light system, activation of a turn signal indicator, light control, or the like.

By way of the classification, for example, an obstacle may be recognized, irrespective of whether it lies directly in the driving direction or adjacent thereto. Depending on the localization (for example, in dependence on the expected vehicle trajectory), a corresponding control action such as deceleration or evasive action may be initiated.

For example, braking may furthermore be initiated if the classification indicates that obstacles are located in the direction of travel and/or that a collision is probable. It is also conceivable that a lane and/or a lane boundary are recognized on the basis of the classification in order to move the vehicle at least partially automatically on the lane by way of the control action.

The "classification" and "image classification" may also comprise "object detection" or "object detection in images." This is understood, in particular, to mean a classification of whether objects are present in certain regions of the image or not. Furthermore, the terms "classification" and "image classification" may also refer to "semantic segmentation", in particular, in the form of a pixel-wise classification.

Accordingly, at least one trained machine learning model may result from the training, which may be used for classification and/or object detection. The use and thus the inference may be provided, for example, in a vehicle. The data points of the input data may, for example, be or be based on pixels of image data in order to thus carry out the classification and/or object detection of the data points on the basis of the pixels. The input data may comprise sensor and/or image data that at least partially result from a detection with a sensor, preferably a camera sensor, and/or that have been at least partially synthesized, that is to say, in particular, replicate the real data of a sensor. Specifically, it may be provided that an environment of a sensor and/or of a vehicle and/or a traffic scene is represented by the values of image points, preferably pixels, of the image data. A classification, preferably image classification and/or object detection, may be provided on the basis of these values. This enables, for example, objects of the traffic scene to be detected. The image data may, for example, be images of a radar sensor and/or of an ultrasonic sensor and/or of a LiDAR sensor and/or of a thermal imaging camera. Accordingly, the images may also be embodied as radar images and/or ultrasound images and/or thermal images and/or lidar images.

A further aspect of the disclosure is a computer program, in particular, a computer program product, comprising instructions that, when the computer program is executed by at least one computer, cause the computer to carry out the method according to the disclosure. The computer program according to the disclosure thus provides the same advantages as those described in detail with reference to a method according to the disclosure.

The disclosure also provides an apparatus for data processing, which is configured to carry out the method according to the disclosure. At least one computer that executes the computer program according to the disclosure may be provided as the apparatus, for example. The computer may comprise at least one processor for executing the computer program. A non-volatile data memory may also be provided, in which the computer program is stored and from which the computer program may be read out by the processor for execution.

The present disclosure further provides a computer-readable storage medium which comprises the computer program according to the disclosure and/or comprises instructions that, when executed by at least one computer, cause the computer to carry out the method according to the disclosure. The storage medium may be embodied as, for example, a data storage device such as a hard disk and/or a non-volatile memory and/or a memory card. The storage medium may, for example, be integrated into the computer.

Furthermore, the method according to the disclosure may also be embodied as a computer-implemented method. Alternatively or additionally, at least one of the disclosed method steps may be computer-implemented and/or carried out in an automated manner.

### BRIEF DESCRIPTION OF THE DRAWINGS

Further advantages, features, and details of the disclosure result from the following description, in which exemplary embodiments of the disclosure are described in detail with reference to the drawings. The features mentioned in the claims and in the description may each be essential to the disclosure individually or in any desired combination. It shows:

FIG. 1 a schematic visualization of a method, an apparatus, a storage medium, and a computer program according to exemplary embodiments of the disclosure,

FIG. 2 a schematic representation of a technical system and an object according to exemplary embodiments of the disclosure.

### DETAILED DESCRIPTION

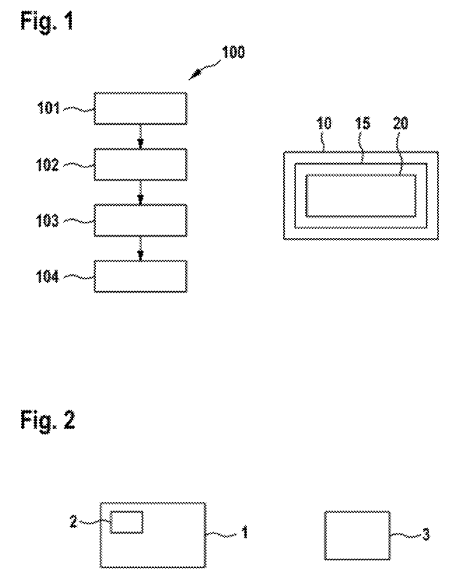

In FIG. 1, a method 100, an apparatus 10, a storage medium 15, and a computer program 20 according to exemplary embodiments of the disclosure are shown schematically.

FIG. 1 shows, in particular, an exemplary embodiment of a method 100 for ascertaining a predictability of at least one object proposal in an object detection, wherein the predictability quantifies a probability of a presence of an object within a bounding box of the at least one object proposal. In a first step 101, an image is provided, wherein the image results from an acquisition of at least one sensor 2 of a technical system 1. In a second step 102, features of the image are extracted. In a third step 103, the at least one object proposal is generated on the basis of the extracted features, wherein the at least one object proposal comprises a bounding box that describes a region within the image that is expected to comprise an object 3. In a fourth step 104, the predictability for the at least one object proposal is ascertained.

FIG. 2 shows a schematic representation of a technical system 1, in particular, a vehicle, having a sensor 2 and an object 3 according to exemplary embodiments of the disclosure.

For object detection, Faster R-CNN is an example of an algorithm that is specifically designed for object detection and may enable objects to be identified and localized in images. Faster R-CNN first scans the image with a region proposal network (RPN) in order to identify potential object-containing regions or "proposals." Each proposal is then examined in detail in order to determine which object it is and where it is located precisely. This includes, for example, a classification of a type of the present object and a refinement of a bounding box, which specifies the exact position and size of the object in the image. Essentially, Faster R-CNN functions, in particular, as an efficient and precise system for detecting, labeling, and localizing objects in images and thus optimizes the process of understanding and interpreting visual data.

According to exemplary embodiments of the disclosure, a concept of a predictability metric is proposed. This metric is intended, in particular, to provide a coherent assessment for regions within an image in which the machine learning model may have difficulty accurately predicting a presence of objects. According to the disclosure, a machine learning model, in particular a further output layer, preferably a classifier head, is used, which receives proposals for bounding boxes from a region proposal network (RPN) as input and evaluates a probability that each proposal comprises an object. This probability corresponds, in particular, to a value of the predictability, which may be derived from a targeted training signal on the basis of ground-truth data. This predictability metric may complement existing uncertainty measures and enable a more comprehensive safety assessment.

By combining the predictability according to the disclosure with traditional uncertainty quantifications, a robust assessment of a reliability of object detection systems in autonomous vehicles may be enabled. This dual approach, in particular, not only improves a safety argumentation for a use of these technologies, but may also represent a significant advancement in the development of truly autonomous driving systems that are capable of dealing with the uncertainties of the real world.

Unpredictability, or predictability, proves, in particular, to be a valuable metric that may complement the traditional uncertainty measures within object detection frameworks.

According to exemplary embodiments of the disclosure, a value for a predictability is ascertained for each generated proposal of a region proposal network (RPN). By assigning a unique value for the predictability to individual object proposals, it may become possible to localize specific regions within an image that may represent a safety risk. This level of detail enables, in particular, more targeted identification of regions in which a performance of the machine learning model, or object detection system, is uncertain or is likely to fail.

The use of the predictability according to the disclosure may enable an implementation of proactive safety measures. In scenarios in which, for example, regions having high unpredictability, or low predictability, are identified, which may indicate a lack of confidence in the detection of objects, a warning message may be triggered so that a driver takes control of the vehicle again. This direct use of the predictability, in particular, not only increases a safety of autonomous driving systems, but also provides, for example, a mechanism for mitigating risks associated with undetected objects or uncertain detections. By integrating the predictability as a complementary metric to uncertainty, autonomous driving systems may achieve an increased level of safety awareness and responsiveness to potential hazards in the driving environment.

According to the disclosure, a more detailed and nuanced understanding of the capabilities of a machine learning model may be enabled by focusing on a local predictability. In contrast to the broader assessment per image, the method according to exemplary embodiments of the disclosure provides, in particular, insights that may be significantly more detailed and thus more relevant for safety-critical applications. By identifying specific unpredictable, or non-predictable, regions within an image, a thorough assessment of the potential risk represented by each region may be carried out, including a probability of a collision with the vehicle. This enables, in particular, a more precise assessment of the situation, enables targeted interventions, and increases the overall safety of autonomous driving systems.

The disclosure may be used for analyzing data that originate from a sensor. The sensor may determine measurements of the environment in the form of sensor signals that may be provided, for example, by digital images, for example, video, radar, LiDAR, ultrasound, motion, thermal images, audio signals, time series.

On the basis of the sensor signal, information about elements encoded by the sensor signal may be obtained, that is to say, an indirect measurement may be carried out on the basis of the sensor signal, which is used as a direct measurement.

The disclosure may be used for classifying the sensor data, for detecting the presence of objects in the sensor data, or for performing semantic segmentation of the sensor data, for example, with respect to traffic signs, road surfaces, pedestrians, vehicles, defects in products of the production line. This is carried out, in particular, on the basis of low-level features, for example, edges or pixel attributes for images.

The disclosure may be used for determining a continuous value or a plurality of continuous values, that is to say, for carrying out a regression analysis, for example, with respect to tracking an element, for example, an object, in the data or for estimating a capability value.

The disclosure may be used for detecting anomalies in a technical system. This is carried out, for example, in the following manner: This disclosure may predict anomalies in the sensor data by predicting a value of the predictability for local proposals. This value may be used in safety applications to estimate the model capability during runtime.

The disclosure may be used to compute a control signal for controlling a technical system, for example, a computer-controlled machine, such as a robot system, a vehicle, a household appliance, a power tool, a production machine, a personal assistant, or an access control system. The disclosure may also be used for analyzing data, for example, scalar time series, in particular from a sensor, namely a camera, and for subsequently controlling the technical system accordingly. The disclosure may also be used for detecting anomalies and for subsequently controlling the technical system in a safe mode. The disclosure may also be used for identifying a cause of the anomaly and for deriving countermeasures, namely for transferring control of the vehicle to the driver.

The disclosure may be used for selecting suitable data points for training a machine learning model by selecting training data using the same method and for testing/verifying/validating a machine learning system by selecting difficult cases using the predictability metric.

The disclosure may be used for actively selecting data that a technical system transmits to a back-end computer, thereby reducing data traffic, which in turn may use this information for training a machine learning model and for testing/verifying/validating a machine learning model. This may take place in the following manner: Data may be actively selected by measuring the predictability for each image and/or each box. This thus also provides, in particular, a measure for an outlier, which describes situations in which a current machine learning model is not able to predict an object that is actually present. This may improve the strategies for data selection, which are often not able to handle false negative (FN) predictions.

The following parts of the disclosure may be computationally parallelized: Uncertainty and predictability may be parallelized in order to achieve the advantage that the inference time is not or is only insignificantly increased.

The integration of the predictability according to the disclosure into a machine learning model, in particular an object detection model, comprises, in particular, an integration of a specific component that serves to assess a confidence level of the machine learning model in detecting objects in specific regions of an image. This component preferably operates in conjunction with conventional object detection mechanisms and analyzes an output of a region proposal network (RPN) in order to identify regions in which the predictions of the machine learning model are less certain. For each proposed region, a value of the predictability quantifies a reliability of the machine learning model and may highlight regions that may require further examination or alternative processing. By directly embedding this functionality into an object detection pipeline, the machine learning model may dynamically adapt its processing strategy or mark specific regions that need to be examined more closely either by human operators or by supplementary automated systems. This approach, in particular, not only improves the capability of the machine learning model to handle ambiguous or challenging scenarios, but may also contribute significantly to the overall safety and reliability of autonomous systems by providing a more comprehensive understanding of the perception limits of the machine learning model.

The following pseudocode describes the method according to exemplary embodiments of the disclosure, which aims to improve the reliability of autonomous driving systems by integrating the predictability into object detection tasks. The method according to the disclosure preferably operates in a continuous loop and begins, in particular, with a sampling of images from a dataset and a use of a region proposal network (RPN) in order to generate object proposals for potential foreground regions in each image. These object proposals are then preferably analyzed in order to predict bounding boxes and to ascertain a value of the predictability for each proposal. As part of a training, the predicted bounding boxes may be compared with ground-truth data in order to identify true positives and false positives. Subsequently, for proposals that have been classified as either true positives or false positives, a value of the predictability is calculated in order to quantify a confidence of the machine learning model in its predictions. Furthermore, a relevance of each proposal for the current autonomous driving scenario may be assessed, and a focus may be placed on potential effects of detected or non-detected objects on immediate driving decisions. It is crucial, in particular, that, if a situation having high uncertainty or unpredictability is present that is considered relevant for the driving context, control may be transferred to the human driver, thereby acknowledging that the machine learning model is not sufficiently reliable for safe navigation. This safety framework according to the disclosure may represent a proactive approach to ensuring the safety of autonomous vehicles by enabling human intervention in scenarios in which a confidence of the machine learning model falls below a predetermined threshold, and thereby addressing the challenges of accurately interpreting complex driving environments.
1: while true do
2: Sample an image from the dataset
3: Infer RPN to get Object Proposals for Foreground Regions
4: for each Proposal do
5: Calculate Box Predictions from Proposals
6: Calculate Unpredictability for Proposal
7: Compare Predictions with Ground Truth
8: if TP or FP then
9: Calculate Uncertainty
10: end if
11: Check Relevance for Current Autonomous Driving Situation based on Locations of Boxes
12: end for
13: if relevant situation with high uncertainty or high unpredictability then
14: Give over control to Driver, because system is not certain enough
15: end if
16: end while

The foregoing explanation of the embodiments describes the present disclosure exclusively within the scope of examples. Individual features of the embodiments may, of course, be combined with one another as desired, provided that this is technically meaningful, without departing from the scope of the present disclosure.

What is claimed is:

1. A method for ascertaining predictability of at least one object proposal in object detection, wherein the predictability quantifies a probability of a presence of an object within the bounding box of the at least one object proposal, the method comprising:
providing an image, wherein the image results from a detection of at least one sensor of a technical system;
extracting features of the image;
generating the at least one object proposal on the basis of the extracted features, wherein the at least one object proposal includes a bounding box that describes a region within the image that is expected to comprise an object; and
ascertaining the predictability for the at least one object proposal.

2. The method according to claim 1, further comprising:
comparing the ascertained predictability of each object proposal with a defined threshold value; and
carrying out at least one measure as a function of a result of the comparing.

3. The method according to claim 2, wherein the technical system is a vehicle and the at least one measure is selected from:
initiating automated control of the vehicle,
initiating a transition from automated control of the vehicle to manual control of the vehicle, and
initiating an output of a warning message in the vehicle.

4. The method according to claim 2, further comprising:
performing object detection on the basis of the extracted features of the image; and
determining a respective relevance of the at least one generated object proposal with regard to a current driving situation on the basis of an analysis of a result of the object detection and a position of the at least one generated object proposal in the image,
wherein the at least one measure is furthermore carried out as a function of the determined respective relevance of the at least one generated object proposal.

5. The method according to claim 2, further comprising:
determining an uncertainty of the bounding box of the at least one generated object proposal,
wherein the at least one measure is furthermore carried out as a function of the determined uncertainty of the bounding box of the at least one generated object proposal.

6. The method according to claim 1, wherein the generating of the object proposals is carried out using a region proposal network and the at least one object proposal is class-independent.

7. The method according to claim 1, wherein the ascertaining of the predictability is carried out using a trained machine learning model, and wherein the machine learning model is trained in the context of a training that comprises at least the following steps:
providing training data, wherein the training data comprise individual images, wherein at least one bounding box is respectively assigned to the individual images, wherein at least a part of the bounding boxes comprises a representation of an object, wherein an annotation is respectively assigned to the bounding boxes, the annotation indicating whether the respective bounding box comprises the representation of the object or not,
predicting the probability of the presence of the object within the bounding boxes using the machine learning model,
checking, on the basis of the corresponding annotations, whether the respective bounding box comprises the representation of the object and the presence of the object was correctly predicted within the scope of the prediction, and
adjusting parameters of the machine learning model on the basis of a result of the checking.

8. A computer program, comprising instructions that, when the computer program is executed by at least one computer, cause the computer to carry out the method according to claim 1.

9. An apparatus for data processing, which is configured to carry out the method according to claim 1.

10. A computer-readable storage medium, comprising instructions that, when executed by at least one computer, cause the computer to carry out the steps of the method according to claim 1.
